(19) United States
(12) Patent Application Publication
(10) Pub. No.: US 2006/0240731 A1
(43) Pub. Date: Oct. 26, 2006

(54) Fire Resisting Composition

(76) Inventor: Ian Summerfield, Doncaster (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/279,827

(22) Filed: Apr. 14, 2006

(30) Foreign Application Priority Data
Apr. 20, 2005 (GB) 0507948.8

(51) Int. Cl. C03C 8/08; B32B 27/04; B32B 18/00

(52) U.S. Cl. 442/142; 501/24; 428/210

(57) ABSTRACT

A fire resisting composition for use in a fire resisting glazing product comprising epoxy resin, acid anhydride, phosphorous based flame retardant, coupling agent, and reactive diluent. A method of making the fire resisting glazing product using the fire resisting composition as provided.

### CROSS-REFERENCE TO RELATED APPLICATIONS

This application claims the benefit, under 35 U.S.C. 119(a), of U.K. Application Serial No. GB0507948.8, filed Apr. 20, 2005, entitled “Fire Resisting Composition,” which application is hereby incorporated by reference.

### BACKGROUND OF THE INVENTION

Although annealed float glass has been produced for many years, its safety characteristics with respect to fire resistance as required by British, European and World standards are insufficient. There are several methods of upgrading annealed float glass to satisfy British, European and World safety standards. These include tempering, incorporating a PVB layer between two glass panels, applying a plastic film or adding a second glass panel and introducing a plastics layer between the two glass panels and bonding them together. Typically, the latter method uses liquid plastics materials.

According to European standard BS EN 1364-1: 1999 (superseding BS 476: Part 22: 1987), fire resisting tests for non-load bearing elements, which includes fire resisting glass products, are classified in three ways. Letters are used to classify three fire performance levels as ‘E’, ‘W’ and ‘I’. The letter ‘E’ represents the integrity, and it measures the ability of the glazing product to provide a physical barrier against flame, hot gases and smoke. The letter ‘W’ represents the radiation, and it measures the ability of the glazing product to reduce the transmission of radiant heat through the glazing product below a specified level e.g. 15 kW/m². This category is a requirement in only a few EU countries. The letter ‘I’ represents the insulation, and it measures the ability of the glazing product to reduce heat conduction through the glazing product to the non-fire side. Currently all insulating fire glass types are multi-laminated in construction or contain a thick polymer interlayer.

Generally, a glazing product is used. Such glazing products generally include at least two glass sheets spaced apart and at least one plastics material interlayer. The two glass sheets define a cavity into which the interlayer of plastics material is introduced.

Methods of laminating annealed float glass panels together are well known. For example, one method uses a polyester resin, vinyl polymers and epoxy thermosetting resin as suitable materials for laminating glass panels together; and makes laminates from frangible materials. It is known in the prior art that laminating bespoke glazing products together by using liquid resin systems may form a safer glass. In addition, there are a number of glazing products, which use acrylic, silicon, UV cure polymers, methacrylate resin or polyester resins. Presently, some of the more popular systems include polyester thermosetting systems. Polyester resin systems provide efficient, low start-up costs and economical ways to bond two pieces of glass together. The polyester resins used in these systems have a low viscosity, which facilitates air release after mixing. As a result, they offer excellent flow characteristics. Such systems, however, have a styrene content that necessitates good ventilation and adequate fire safety precautions.

While the laminated glazing products described above have adequate mechanical properties for strengthening, they may be inadequate for use in a laminated fire resisting glazing product. Even when the materials are modified with fire retardant additives, their results are still not on par with the standards for fire resisting glazing products.

Other known methods in the prior art include a glazing product that is manufactured using an epoxy based resin material. This method includes making a fire resisting laminated glazing product and heating the resin. Generally, epoxy based resin materials, when incorporated as an interlayer between annealed glass sheets, help improve the fire resistance of fire resisting glazing products. At normal operating temperatures (25° C.), however, the epoxy based liquid resin materials remain too viscous to spread evenly when poured between the annealed glass sheets. Consequently, air bubbles are introduced into the epoxy based resin material, which not only is unsightly for a transparent glazing product, but also detrimentally affect the fire resisting properties. While the addition of a diluent may reduce the viscosity of the epoxy based resin material, the diluent also reduces the fire resisting properties of the glazing product and increases the risk of trapped air bubbles in the epoxy based resin material. A solution to this problem involves the introduction of the epoxy based resin material into a cavity formed between two glass sheets at an elevated temperature. Subsequently, a force is applied to the glass sheets in order to evenly spread the epoxy based resin material between those two sheets. In such instances, an elevated temperature of the resin is required to perform the following: reduce viscosity, enable the addition of other chemical elements, permit the release of air, and facilitate the pouring between two glass panels.

Another example in the prior art describes the need to raise the temperature of the annealed glass panels into which the resin is poured. In such instance, the temperature should be similar to that of the mixed resin material in order to maintain the viscosity necessary to enable the flow of the resin in a cavity formed between the glass panels. After pouring the liquid resin and forming a glazing product, large heated plates are used in order to level the liquid resin material and make a glazing product of uniform thickness. Heat curing is then used to set the resin.

The processing used for elevated temperatures generally require more time and money. Furthermore, an elevated temperature accelerates the curing time of the resin, thus, reduces the effective working time of the liquid resin before it cures to a few minutes. In extreme cases, little or no air release may be achieved during manufacture of a fire resisting glazing product.

Typically, a wired fire resisting glazing product includes interleaving wires to improve the mechanical strength and stability of the glazing product. The resin thickness of the glazing product is described as no more than 3 mm., e.g. 1.2 mm. However, for a glazing product without wires, a resin thickness of up to 12 mm. or more may be required. This method requires many processes in order to achieve a laminated panel of glass. Furthermore, to produce a unit without wires a very thick resin layer is necessary, which may add considerable cost and result in optical distortions.

### SUMMARY OF THE INVENTION

In view of the issues discussed above, Applicant has devised a blend of materials with a viscosity suitable for pouring a fire resisting resin between two panels of glass without needing to heat the resin system or the glass panels prior to casting. The resulting fire resisting glazing product provides a stable transparent non-wired laminated fire glass. The fire glass comprises a resin layer that forms an effective fire barrier.

In a general aspect, the application is directed to a fire resisting composition for use in a fire resisting glazing product. The composition includes an epoxy resin, an acid anhydride, a phosphorus based flame retardant, a coupling agent and a reactive diluent. The epoxy resin is 20.0% to 60.0% by weight of the composition, the acid anhydride is 20.0% to 30.0% by weight of the composition, the phosphorus based flame retardant is 15.0% to 20.0% by weight of the composition, the coupling agent is 1.0% to 2.0% by weight of the composition, and the reactive diluent is 3.0% to 10.0% by weight of the composition.

The above aspect may include one or more of the following features. In one embodiment, the composition further includes an accelerator. The accelerator is configured to reduce the cure time of said composition, and said accelerator is 0.5% to 1.0% by weight of said composition. The accelerator also may include a tertiary amine. Another embodiment is directed to a composition wherein the accelerator is selected from one or more of benzyldimethylamine and tris dimethyl amino-methyl phenol. In another embodiment, the accelerator may include an imidazole. In another embodiment, the accelerator includes 2-ethyl-4-methyl-imidazole.

Another embodiment is directed to a composition including an ultraviolet light absorber. The ultraviolet light absorber is 0.5% to 5.0% by weight of the composition. The ultraviolet light absorber may include benzotriazole, benzophenone, or triazine. In another embodiment, the composition includes an ultraviolet light stabilizer. The ultraviolet light stabilizer is 0.5% to 5.0% by weight of the composition. The ultraviolet light stabilizer may include a hindered amine, a hindered phenol, or a hindered benzoate.

In another embodiment, the composition includes a halogen flame retardant that is 5.0 to 10% by weight of the composition. In some embodiments, the halogen flame retardant includes a bromine-based compound. Still other embodiments are directed to compositions in which the epoxy resin includes an epoxy novolac, the reactive diluent includes 1,4-butane diglycidyl ether or 1,6-hexane diglycidyl ether and/or the coupling agent includes an alkoxysilane.

In another embodiment, acid anhydride includes methyl tetrahydrophthalic anhydride, methyl hexahydrophthalic anhydride, dodecenylsuccinic anhydride (DDSA), or nadic methyl anhydride.

In another embodiment, the composition includes an accelerator, a halogen flame retardant and a UV absorber. The epoxy resin may include epoxy novolac, which is 41.0% to 43.0% by weight of the composition. The accelerator may include a tertiary amine, which is 0.5% to 1.0% by weight of the composition. The halogen flame retardant may include a bromine-based compound. The acid anhydride may include 23.6% to 25.0% by weight of the composition. The phosphorus based flame retardant may include 17.0% to 18.5% by weight of the composition. The bromine based flame retardant may include 5.0% to 7.5% by weight of the composition. The reactive diluent may include 4.7% to 6.5% by weight of the composition. The UV absorber may include 1.0% to 3.0% by weight of the composition.

In another aspect, the composition for use in a fire resisting glazing product includes an epoxy resin and a flame retardant. The composition may have a viscosity of less than 400 centipoise at 25° C. In one embodiment, the composition may have a viscosity of about 350 centipoise at 25° C.

Another aspect includes a method of making a laminated fire resisting glazing product. The method includes the steps of: spacing a first glass sheet and a second glass sheet apart such that the second glass sheet is disposed substantially parallel and opposing the first glass sheet, at a first temperature. The method also includes the steps of sealing at least three edges of the glass sheets, such that the first glass sheet and the second glass sheet define a cavity there between. The method also includes introducing an epoxy based resin composition into the cavity at a second temperature. The second temperature may be substantially room temperature. In addition, the method includes curing the first glass sheet, the second glass sheet and the epoxy based resin composition for a time at a third temperature, thereby forming the laminated fire resisting glazing product.

In some embodiments, the epoxy based resin composition may include an epoxy resin, an acid anhydride, a phosphorus based flame retardant, a coupling agent, and a reactive diluent. The epoxy resin may be 20.0% to 60.0% by weight of the epoxy based resin composition. The acid anhydride may be 20.0% to 30.0% by weight of the epoxy based resin composition. The phosphorus based flame retardant may be 15.0% to 20.0% by weight of the epoxy based resin composition. The coupling agent may be 1.0% to 2.0% by weight of the epoxy based resin composition. The reactive diluent may be 3.0% to 10.0% by weight of the epoxy based resin composition.

Another embodiment includes a method in which the time is about 2 hours and the third temperature is about 135° C. Still another embodiment includes a method where the time is about 2 hours and the third temperature is about 135° C.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a side elevation view of an epoxy based resin material being introduced between two spaced apart glass sheets.

FIG. 2 illustrates schematically a cross-section of glazing products having one or more epoxy resin based laminate layers.

FIG. 3 illustrates a flow diagram of a process for making laminated fire resisting glazing products.

### DETAILED DESCRIPTION OF THE INVENTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

A laminated glass panel is produced using a pair of annealed (ordinary) float glass sheets being spaced apart in parallel relationship, and sealed at their edges to form a cavity. A liquid thermosetting resin is introduced into the cavity and subsequently cured to form a glass lamination providing fire resistance and safety characteristics.

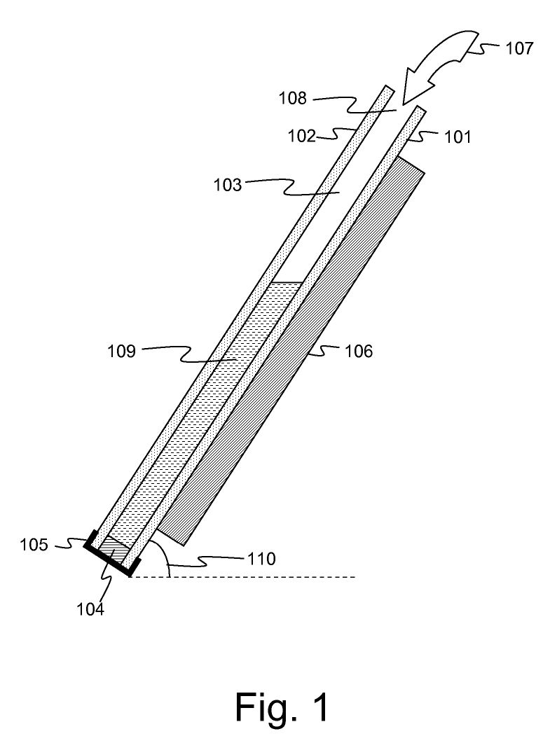

Referring to FIG. 1 herein, there is illustrated schematically a side elevation view of an epoxy based resin material being introduced between two spaced apart glass sheets. There is provided a first glass sheet 101, a second glass sheet 102, which have a cavity 103 between them. Each sheet has four edges. Towards three of the four edges, a spacer 104 is placed to maintain the sheets 101, 102 in a substantially parallel relationship. A further adhesive seal 105 is also provided on the outside of the three edges.

Annealed float glass is used for the first glass sheet 101 and the second glass sheet 102, as it is commonly found in modern buildings and, as opposed to drawn glass, is manufactured world-wide and is readily available from a large number of glass merchants. The glass sheets 101, 102 can range in size from as small as 50 mm.×50 mm. to as large as 5.00 m². Patterned, textured, tinted, etched, brilliant-cut, painted, screen printed or otherwise processed glass, as fire tested or assessed, can also be incorporated as one of the glass panels 101, 102 making up the fire resisting laminated unit. The glass sheets 101, 102 may be from 2 mm to 19 mm thick. Whatever thickness is selected, both sheets of glass 101, 102 for a 3-ply fire resisting glazed product must be of a similar thickness.

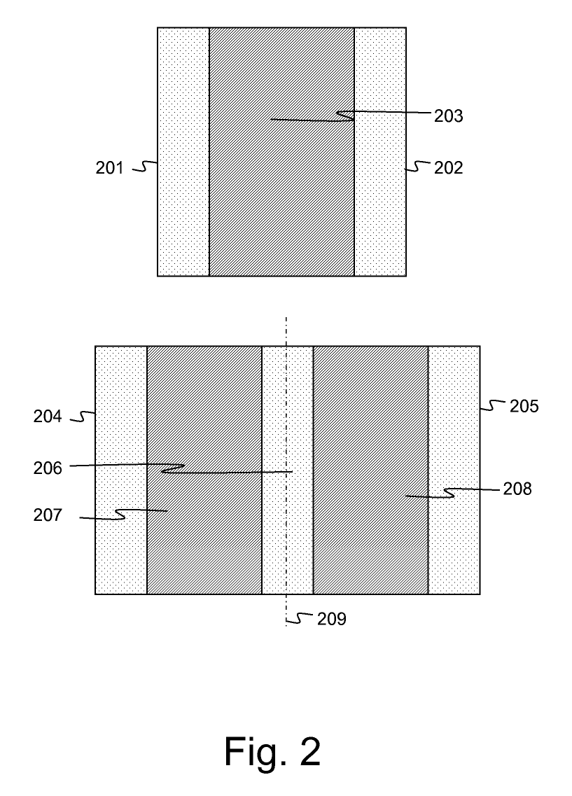

By a 3-ply unit, it is meant a unit comprising a first glass sheet 101, a layer of resin, and a second glass sheet 102 such that the layer of resin is sandwiched between the first glass sheet 101 and the second glass sheet 102. Fire resisting glazing units having more than 3-ply construction can also be manufactured. Referring to FIG. 2 herein, there is illustrated schematically a cross-section of glazing products having one or more epoxy resin based laminate layers. In FIG. 2A there is illustrated a 3-ply fire resisting glazing product comprising a first glass layer 201, a second glass layer 202, and a resin layer 203 sandwiched between the first glass layer 201 and the second glass layer 202. In FIG. 2B there is illustrated a 5-ply fire resisting glazing product comprising a first glass layer 204, a second glass layer 205 and a third glass layer 206. There is also provided a first resin layer 207 and a second resin layer 208. The first resin layer 207 is sandwiched between the first glass layer 204 and the third glass layer 206, and the second resin layer 208 is sandwiched between the second glass layer 205 and the third glass layer 206.

Whatever configuration of ply is used, the fabricated fire resisting glazing product should be symmetrical about a centre line 209 through the thickness of the product. This is to ensure that the product has the same fire resisting properties regardless of which side a fire is, and to ensure that if a fire is only expected on one side of a product (for example, the interior of a building), the fire resisting glazing product cannot be accidentally installed the wrong way round.

The spacer 104 the perimeter of the glazing product comprises double sided adhesive tape. The thickness of the tape determines the width of the cavity 103 between the first glass sheet 101 and the second glass sheet 102. A resin thickness of between 1 mm. to 3 mm. is preferred, and typically 1.1 mm. is used. Suitable double sided adhesive tapes are manufactured from urethane foam, PVC foam, foamed acrylic and polyolefin foams. Foamed acrylic tapes are preferred as they offer good bonding to the glass sheets 101, 102 and display sufficient hardness to withstand the weight of the upper glass panel without compressing, which if compressed would result in reduced cavity 103 thickness. Foamed acrylic tapes also withstand the temperatures at which the fire resisting glazing product is exposed to during the elevated temperature curing process.

In addition to spacer 104, a further adhesive seal 105 comprising a self-adhesive aluminum foil tape is placed around the outside edges of the first glass sheet 101 and the second glass sheet 102. This further seals the edges of the glass sheets 101, 102 prior to heat curing, to act as a secondary seal in the event any small amount of resin material escapes before it is fully cured. The aluminum foil tape also offers protection to the edges of the glass and protection to operatives working with the glazing product.

An epoxy resin blend 109 is introduced 107 into the cavity 103 between the first glass sheet 101 and the second glass sheet. The epoxy resin blend comprises fire retardant materials. The epoxy resin blend 109 is introduced into the cavity 103 at the edge 108 where there is a gap in the spacer 104 such that epoxy resin blend can be poured into the cavity 103 and air can be released from the cavity 103.

Epoxy resin is a thermosetting resin and is known for good resistance to heat. Common types of base epoxy resin include, phenolic, novolac, bisphenol A, bisphenol F and bisphenol A/F mixture resins and these resins are used in composites, coatings, adhesives, encapsulation and electrical applications, civil and mechanical engineering products. The most widely used epoxy resin is a bisphenol A epoxy resin. Of all these epoxy resins, phenolic and novolac resins are known to have higher resistance to heat. However, phenolic resins are dark in colour and therefore unsuitable for this application as transparency is required.

A suitable epoxy resin is Epoxy novolac resin. Epoxy novolac resin in its base form is very viscous and chemical manufacturers may supply epoxy novolac resins already mixed with a reactive diluent to provide a less viscous more workable product. If necessary, a reactive diluent can be added to facilitate processing by providing a more pourable resin. There are a range of diluents available including mono-functional, di-functional and multi-functional displaying suitable characteristics. From this range typically a 1,4-butane diglycidyl ether or 1,6-hexane diglycidyl ether can be reacted with the novolac resin.

Thermosetting resin systems such as epoxy novolac resins require a curing agent or hardener to react with the resin in order to achieve a solid cured material. Epoxy novolac hardeners include aliphatic amines, amidoamines, polyamides, polyimides, polyetheramines, cycloaliphatic amines, aromatic amines, latent imidazole, acid anhydrides and latent catalytic agents.

A novolac resin, diluent and hardener mix has been found to be incapable of withstanding the extreme heat of a British or European Standard fire test. Additional modifications are therefore required to achieve a resin in a fire resisting glazing product to withstand the extremes of a fully developed fire. There are an abundance of fire retardant additives that provide assistance to polymer materials reaction to extreme heat. However, it has been found only a limited number of fire retardants are suitable for use in an application such as this where transparency is an important characteristic. Suitable fire retardant additives can have a phosphorus content, e.g. resorcinol bis diphenyl phosphate, bisphenol A bis diphenyl phosphate and isopropylated triphenyl phosphate. These compounds offer clear, low viscosity advantages. Other suitable fire retardant additives include phosphite additives, aryl or alkyl phosphite or a mix of both and diaryl or dialkyl hydrogen phosphites, suitably triphenyl phosphite, triisodecyl phosphite or a diphenyl phosphite, which displays a higher phosphorus content. Phosphite compounds also have the advantage of acting as a polymer stabilizer and under extreme heat exposure certain elements undergo a chemical change to form a sticky substance that adds stability to the fire resisting glazing unit.

It has been found that halogen fire retardant products are also helpful with achieving a good reaction against extreme heat and bromine materials are known to be more effective than chlorine materials. Most bromine based flame retardants are commercially available in powder form, although some are available in liquid form and it is preferred to use a liquid bromine based flame retardant. Liquid halogen based flame retardants can increase the viscosity of the blend.

The fire retardant products described above are not designed for the present invention, as placed between two or more glass panels, but rather for applications to prevent the surface spread of flame. Annealed float glass will not support the surface spread of flame. However annealed float glass will vent on exposure to rapid temperature rises and through those vents provide an avenue for oxygen supplies to the polymer material it surrounds fanning the combustion process when exposed to high temperatures. A phosphorous-based flame retardant acts mostly by physical action in the condensed phase by providing a protective layer thereby reducing available oxygen and impeding the combustion process. Phosphorous based flame retardants also react in the solid phase by forming a carbon layer on the polymer surface.

A halogen flame retardant acts mainly in the gas phase by a chemical reaction to suppress the combustion process. The exothermic combustion process is slowed and the supply of flammable gases from the resin are reduced.

It has been found that phosphorous flame retardant materials and halogen flame retardant materials added to a novolac resin work well in providing resistance to extreme heat during the different stages of the combustion process the resin endures. It has also been found that the combination of phosphorous and halogen flame retardant materials utilized in this way gives greater stability to the novolac resin during pyrolysis and succeeds in providing support to the fire resisting glazing product during exposure to extreme heat. It has also been found that the resulting char formed on combustion of incorporated phosphorous and halogen flame retardant materials produces a solid charred layer which in effect supports the glass sheets 101, 102 in their fractured condition during exposure to extreme heat. Whilst it is preferred to use a combination of a halogen flame retardant and a phosphorous flame retardant, it is not essential that the blend includes a halogen flame retardant as adequate results can be achieved using only the phosphorous flame retardant. Under conditions of fire, the phosphorous flame retardant becomes sticky and assists in maintaining the mechanical stability of the glazing point up until the point where the phosphorous flame retardant begins to char.

Since epoxy resins have an aromatic structure, they can be affected to some extent by ultraviolet (UV) light and in almost all situations for glazing products, this originates from the sun. The effect of UV light is to cause the transparent epoxy resin to lend the glazing product an undesirable yellow color, or in extreme cases to become opaque. This is detrimental to the appearance of the fire resisting glazing product. An ultraviolet light absorber is used to overcome the effects of ultraviolet light. There are a number of known ultraviolet light absorbing products suitable for inclusion into a novolac resin system and they include a benzotriazole or benzophenone and a more recent addition known as triazine.

Recent advancements to polymer additives that resist the effects of sunlight exposure are hindered amine, hindered phenol and hindered benzoate light stabilizers, which act as free radical scavengers in the polymer system. These additives are not ultraviolet light absorbers, but ultraviolet light stabilizers and for some compositions may be used in place of an ultraviolet light absorber.

The float glass on each side and an ultraviolet absorber or stabilizer within the resin system provide a stable laminated fire resisting glazing product. Many ultraviolet absorbers are commercially available in powder form, and can be mixed with a reactive diluent before incorporating into the blend. Where transparency is not a requirement of the glazing product, an ultraviolet absorber is not required.

It is desirable to include a coupling agent to improve adhesion between the organic epoxy resin layer 109 and the glass sheets 101, 102. It is known that alkoxysilanes improves the ability of an epoxy resin to bond to a glass surface. It has been found that an alkoxysilane material offers additional adhesion of the resin system to the glass sheets 101, 102 of the present invention especially when exposed to extreme heat. Alkoxysilanes can be included in the blend of materials making up the resin mix or they can be diluted and sprayed onto the inner surface of each glass sheet 101, 102 before assembly or it may be incorporated using a combination of both methods.

There is a range of epoxy novolac hardeners or curing agents that can be used giving a range of final cured resin characteristics. It is desirable to use a curing agent that will lead to a fire resisting glazing product that is capable of withstanding extreme heat. Curing agents that can be used to fabricate a fire resisting glazing product include a latent/catalytic cure system or an anhydride/accelerator cure system.

Anhydride/accelerator cure systems include methyl tetrahydrophathlic anhydride, methyl hexahydrophthalic anhydride, dodecenylsuccinic anhydride (DDSA) and nadic methyl anhydride. The advantage of these materials is that they are slow reacting, which provides extended standing time for air release after mixing. Anhydride systems also have the advantage of providing long gel times, which allow large batches at a time to be mixed for automated feed on larger production line facilities, as they will have a longer ‘pot life’, that is to say large quantities of the resin mix can be prepared beforehand and can be kept for some time before they must be used. Most other amine cure systems would not be practical in automated feed production lines as the gel times are too short and hardened resin would choke feed lines and holding tanks.

Standing times for the anhydride cure systems described above are typically 0.5-1 hour depending on the ambient temperature. A cure accelerator is used to shorten the elevated temperature cure time, that is to say the cure time of the anhydride cure system if the temperature is raised above ambient. Suitable accelerators include tertiary amines (benzyldimethylamine or tris dimethyl amino-methyl phenol) or an imidazoles such as 2-ethyl, 4-methyl-imidazole for the anhydride cure system. The use of a tertiary amine with the acid anhydride system allows a lower quantity of acid anhydride to be used to achieve an adequate cure. It is advantageous to reduce the quantity of acid anhydride used in the mix, as it has been found that a resin containing a high ratio of acid anhydride/resin burns during a fire more freely than a resin containing a lower ratio of acid anhydride/resin. However, it is not essential that a tertiary amine is used as the acid anhydride may achieve an adequate cure given a long enough time, high enough temperature or combination of time and temperature.

Curing the epoxy novolac system of the present invention is achieved by elevated temperature baking in an industrial box oven. An advantage of the present invention is that elevated temperature cycles of a low temperature for a short period then cooling followed by high temperature bake for several hours are unnecessary. It has been found cure rates for an anhydride/accelerator system would be a single cycle of 125° C.-150° C. for 1-3 hours typically 135° for 2 hours. It has also been found that anhydride/accelerator cure systems offer a good glass transition temperature (a temperature measurement of when the cured resin begins to soften under heat conditions), good clarity and optimum characteristics when exposed to short elevated temperature baking.

Alternatively, the fire resisting glazing product can achieve similar fire resisting results substituting a latent/catalytic cure system for the anhydride/accelerator cure system. A similar elevated temperature cure program cycle would be as described before. The disadvantage of the latent/catalytic types is the overall system is more expensive and has slightly less clarity than the anhydride/accelerator cure system. However, latent/catalytic cure systems offer good glass transition temperatures, good clarity, and good cured characteristics.

### EXAMPLE

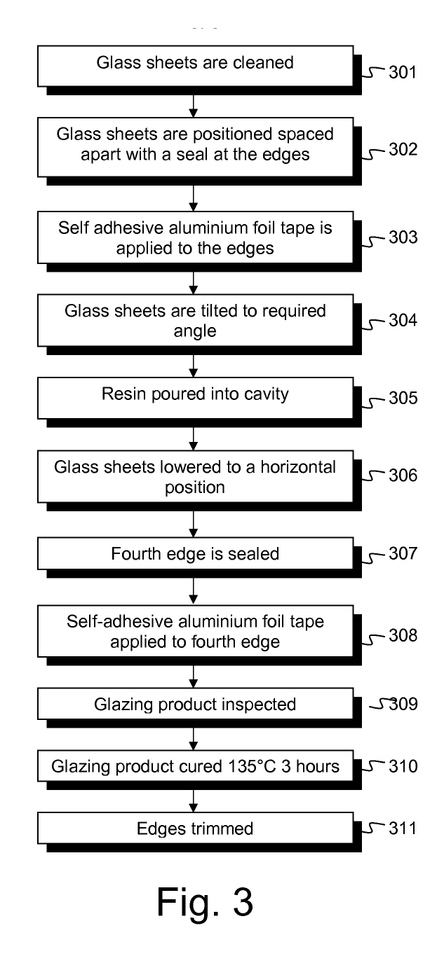

Referring to FIG. 3 herein, there is illustrated a flow diagram of a process for making laminated fire resisting glazing products. A first glass sheet 101 and a second glass sheet 102 of stock size glass of 3 mm or 4 mm thick measuring for example 2440 mm wide×1220 mm high are prepared by first passing them through a glass washing machine 301. Modern machines also dry the glass before the process is finished and in many cases the machine capacity will determine the largest panel of glass that can be cleaned. Glass cleaning can also be achieved manually by use of a proprietary glass cleaner. A thorough visual inspection is carried out before the double-sided adhesive tape is applied.

The first glass sheet 101 is then placed on a horizontal and substantially flat glass table. Double-sided tape 104 is applied on all four sides at the edge of the glass sheet 101. Two small gaps are left at each end of the side, for final air release, in which the liquid resin will be introduced. A protective film or backing film is removed from the upper surface of three sides. The backing film to the fourth side, where the liquid resin is to be introduced, remains until all the liquid resin has been poured between the glass layers. The second clean glass panel is placed above the first and laid on top in a parallel position 302. A seal is formed around the perimeter of the glass sheets 101, 102 to prevent the liquid resin running out from between the glass layers.

Self adhesive aluminum foil tape 105 is then applied 303 forming a channel around three edges, which acts as an additional barrier to any small leaks of resin that may escape through the double-sided adhesive tape 104.

The first glass sheet 101 is supported on a support 106, which is then tilted 304 to a required angle 110 so as to elevate the fourth edge 108, where the backing film has remained. The position or angle 110 of elevation is to suit the flow of resin material to the bottom of the unit.

A measured amount of activated liquid resin material 109 using an anhydride/tertiary amine cure system is poured 305 into the cavity 103 between the first glass sheet 101 and the second glass sheet 102. Owing to the viscosity of the liquid resin material 109 and gravitational forces, the liquid resin flows to the bottom of the cavity 103. As the cavity 103 is filled, the resin 109 moves towards the upper open edge 108. Air is evacuated through the top edge 108.

Final air release is achieved when the unit is lowered 306 to a horizontal position and the liquid resin 109 moves toward the unsealed fourth edge 108 of the unit. At this point the backing film is removed from the tape of the top fourth edge 108, and a seal is formed, apart from gaps left at each end. Final air release occurs through these gaps which are sealed 307 with silicone or similar material to retain the liquid resin material between the glass sheets.

Self-adhesive aluminum foil tape is then applied 308 to this fourth and final edge. At this point, an inspection is made 309 to ensure the glazing product is fully sealed, that there are no residual air bubbles and that there are no vents in the glass before it is moved to the oven for elevated temperature curing. If it is found the seal is inadequate, further aluminum foil tape can be applied. Residual air at the perimeter of the glazing product is acceptable, and air bubbles trapped further towards the centre of the glazing product may be moved by elevating the glazing product to allow the bubble to rise and terminate at the perimeter. Vents in the glazing product will normally render it unusable; it should be discarded in a safe and environmentally approved manner.

After pouring, final inspection and prior to elevated temperature curing, completed glazing products are stored on a suitable rack assembly for bulk cure. A suitable rack assembly allows circulation of hot air all around the glazing products whilst in the oven. It is essential to support and maintain the glazing product in a near horizontal position to prevent the liquid resin material bulking to the lower side. A deviation of no more than 10° to the horizontal is acceptable for producing a uniform thickness of cured resin layer between the glass sheets 101, 102. When the required quantity of units have been fabricated, the rack assembly is rolled into the industrial box oven. Single or multiple glazing products can be cured in this way, however, it is more economical to cure batch quantities at a time.

The glazing product is cured 310 for 2 hours at 135° C. This allows the resin 109 to set and form a solid laminate with the first glass sheet 101 and the second glass sheet 102.

Once the glazing product has been cured, the edges can be trimmed 311 to remove edges where air remains and the adhesive tape 105 and spacer 104.

The blend of the resin is important, as it must have a sufficiently low viscosity at around room temperature to be adequately poured between the two glass sheets 101, 102. If the viscosity of the liquid resin is too high, then the resin may not pour adequately and air bubbles can become entrained in the fire resisting glazing product.

A blend of epoxy novolac resin, reactive diluent, phosphorous fire retardant, halogenated fire retardant, alkoxysilane, ultraviolet light stabilizer and curing system of anhydride/tertiary amine provide a mix that has good clarity, low viscosity and a long pot life. This blend of materials provides a mix that will retain a low viscosity and a stable condition for several days. It allows ample time for air release to take place and is easily suited for batch fabrication of laminated units. It has been found the low viscosity resin mix overcomes the need for a press, to force the unit together making a uniformly thick resin layer, as the resin mix finds its flat level when placed horizontally on the flat glass table. It has also been found unnecessary to heat the epoxy novolac and additives to reduce its viscosity or to heat the glass to maintain a similar temperature to the resin. This is because the low viscosity epoxy novolac resin mix flows freely at room temperature (around 25° C.) and disperses between the glass sheets 101, 102. It has been found a working environment of temperatures between 10 ^{c}o and 30 ^{c}o provides a suitable atmosphere for the epoxy resin blend used.

A suitable blend has been found to be:

| Epoxy Novolac | 41.0-43.0% by weight |
|---|---|
| Reactive Diluent | 4.7-6.5 |
| Acid Anhydride | 23.6-25.0 |
| Phosphorus Flame Retardant | 17.0-18.5 |
| Bromine Flame Retardant | 5.0-7.5 |
| Coupling Agent | 1.0-2.0 |
| Tertiary Amine | 0.5-1.0 |
| UV Absorber | 1.0-3.0 |

This blend can be heat cured at 130°-140° C. for 1.5-2.0 hours. It has been found that this blend has a viscosity as follows:

| | |
|---|---|
| 25° C. | 345 centipoise |
| 26° C. | 278 centipoise |
| 28° C. | 242 centipoise |

This compares to viscosity at 25° C. of the individual components of the blend as follows:

| | | |
|---|---|---|
| Epoxy novolac resin: | 30,000-50,000 | centipoise |
| Acid anhydride: | 45-65 | centipoise |
| Phosphorous flame retardant: | 10-17 | centipoise |
| Halogen flame retardant: | 1,800 | centipoise |
| Coupling agent: | 3 | centipoise |
| Reactive diluent: | 14-21 | centipoise |
| Tertiary amine: | 120-250 | centipoise |

| | |
|---|---|
| UV absorber: | introduced as a powder |

The blend of the above individual components gives the required viscosity of 345 centipoise at 25° C. This viscosity range is suitable for pouring the blend at room temperature.

Suitable space for a ‘clean room’, an environment that is maintained at temperatures between 10° C. and 30° C. and kept relatively dust free, is used for mixing materials and fabrication of the laminated glazing product. Automatic pumps and production line facilities can be set up if required. The glazing product manufacture has low start-up costs or it can be easily incorporated into existing glass tempering production facilities. Glazing products of this type do not require expensive processing machines as production utilizes equipment most medium and large glass companies already have. A further advantage of the current invention is that it utilizes readily available glass panels or stock glass. The glazing product can, for example, be fabricated during the latter hours of the working day allowing an elevated temperature cure overnight by a thermostatic timer on the industrial oven box. New stocks will be ready for cutting and shipping the next day.

According to a second specific embodiment, double glazed units are provided incorporating one or more leaves of the fire resisting glazed product, the other leaf being of clear annealed or tempered or otherwise processed as before described. The spacer bar utilized in double glazed units of the current invention must be that of a stainless steel type to provide the necessary support when exposed to extreme heat.

According to a third specific embodiment, glazed units are provided in a bent curved section configuration.

The glazed products described herein, when manufactured in a 3-ply configuration, can provide fire resistance of 30 minutes expressed as EW30. Further, by increasing the number of laminations, e.g. 3 glass panels and 2 resin layers, fire resistance of E60 can be achieved.

Additionally, the glazed products of 3-ply or multiples thereof comply with the safety requirements of BS EN 12600 (superseding BS 6206: 1981) Impact Test as class 2B, which will allow the glazed products to be used in all applications as defined by e.g. UK Buildings Regulations Part N.

1. A fire resisting composition for use in a fire resisting glazing product comprising an epoxy resin, an acid anhydride, a phosphorus based flame retardant, a coupling agent and a reactive diluent;
wherein said epoxy resin is 20.0% to 60.0% by weight of said composition, said acid anhydride is 20.0% to 30.0% by weight of said composition, said phosphorus based flame retardant is 15.0% to 20.0% by weight of said composition, said coupling agent is 1.0% to 2.0% by weight of said composition, and said reactive diluent is 3.0% to 10.0% by weight of said composition.

2. The composition of claim 1, further comprising an accelerator;
wherein said accelerator is configured to reduce the cure time of said composition, and said accelerator is 0.5% to 1.0% by weight of said composition.

3. The composition of claim 2, wherein said accelerator comprises a tertiary amine.

4. The composition of claim 2, wherein said accelerator is selected from one or more of benzyldimethylamine and tris dimethyl amino-methyl phenol.

5. The composition of claim 2, wherein said accelerator comprises an imidazole.

6. The composition of claim 2, wherein said accelerator comprises 2-ethyl-4-methyl-imidazole.

7. The composition of claim 1, further comprising an ultraviolet light absorber;
wherein said ultraviolet light absorber is 0.5% to 5.0% by weight of said composition.

8. The composition of claim 2, further comprising an ultraviolet light absorber;
wherein said ultraviolet light absorber is 0.5% to 5.0% by weight of said composition.

9. The composition of claim 7, wherein said ultraviolet light absorber comprises benzotriazole, benzophenone, or triazine.

10. The composition of claim 1, further comprising an ultraviolet light stabilizer;
wherein said ultraviolet light stabilizer is 0.5% to 5.0% by weight of said composition.

11. The composition of claim 7, further comprising an ultraviolet light stabilizer;
wherein said ultraviolet light stabilizer is 0.5% to 5.0% by weight of said composition.

12. The composition of claim 10, wherein said ultraviolet light stabilizer comprises a hindered amine, a hindered phenol, or a hindered benzoate.

13. The composition of claim 1, further comprising a halogen flame retardant;
wherein said halogen flame retardant is 5.0 to 10% by weight of said composition.

14. The composition of claim 12, further comprising a halogen flame retardant;
wherein said halogen flame retardant is 5.0 to 10% by weight of said composition.

15. The composition of claim 13, wherein said halogen flame retardant comprises a bromine-based compound.

16. The composition of claim 1, wherein said epoxy resin comprises epoxy novolac.

17. The composition of claim 1, wherein said reactive diluent comprises 1,4-butane diglycidyl ether or 1,6-hexane diglycidyl ether.

18. The composition of claim 1, wherein said coupling agent comprises an alkoxysilane.

19. The composition of claim 1, wherein said acid anhydride comprises methyl tetrahydrophthalic anhydride, methyl hexahydrophthalic anhydride, dodecenylsuccinic anhydride (DDSA), or nadic methyl anhydride.

20. The composition of claim 1, further comprising an accelerator, a halogen flame retardant and a UV absorber;
wherein said epoxy resin comprises epoxy novolac, said accelerator comprises a tertiary amine, and said halogen flame retardant comprises a bromine-based compound; and
said epoxy novolac is 41.0% to 43.0% by weight of said composition, said tertiary amine is 0.5% to 1.0% by weight of said composition, said acid anhydride is 23.6% to 25.0% by weight of said composition, said phosphorus based flame retardant is 17.0% to 18.5% by weight of said composition, said bromine based flame retardant is 5.0% to 7.5% by weight of said composition, said reactive diluent is 4.7% to 6.5% by weight of said composition, and said UV absorber is 1.0% to 3.0% by weight of said composition.

21. A composition for use in a fire resisting glazing product, said composition comprising an epoxy resin and a flame retardant;
wherein said composition has a viscosity of less than 400 centipoise at 25° C.

22. The composition of claim 21, wherein said composition has a viscosity of about 350 centipoise at 25° C.

23. A method of making a laminated fire resisting glazing product comprising the steps of:
spacing a first glass sheet and a second glass sheet apart such that said second glass sheet is disposed substantially parallel and opposing said first glass sheet, at a first temperature;
sealing at least three edges of said glass sheets, such that said first glass sheet and said second glass sheet define a cavity there between;
introducing an epoxy based resin composition into said cavity at a second temperature, wherein said second temperature is substantially room temperature; and
curing said first glass sheet, said second glass sheet and said epoxy based resin composition for a time at a third temperature, thereby forming said laminated fire resisting glazing product.

24. The method of claim 23, wherein said epoxy based resin composition comprises an epoxy resin, an acid anhydride, a phosphorus based flame retardant, a coupling agent, and a reactive diluent;
wherein said epoxy resin is 20.0% to 60.0% by weight of said epoxy based resin composition, said acid anhydride is 20.0% to 30.0% by weight of said epoxy based resin composition, said phosphorus based flame retardant is 15.0% to 20.0% by weight of said epoxy based resin composition, said coupling agent is 1.0% to 2.0% by weight of said epoxy based resin composition, and said reactive diluent is 3.0% to 10.0% by weight of said epoxy based resin composition.

25. The method of claim 23, wherein said time is about 2 hours; and said third temperature is about 135° C.

26. The method of claim 24, wherein said time is about 2 hours; and said third temperature is about 135° C.
